(19) United States
(12) Patent Application Publication
(10) Pub. No.: US 2024/0416425 A1
(43) Pub. Date: Dec. 19, 2024

(54) ADDITIVE MANUFACTURING

(71) Applicant: Sodick Co., Ltd., Kanagawa (JP)

(72) Inventors: Itaru MATSUMOTO, Kanagawa (JP); Tsubasa TAKAYAMA, Kanagawa (JP)

(73) Assignee: Sodick Co., Ltd., Kanagawa (JP)

(21) Appl. No.: 18/677,851

(22) Filed: May 29, 2024

(30) Foreign Application Priority Data
Jun. 13, 2023 (JP) 2023-096768

(51) Int. Cl. B22F 12/41; B22F 10/50; B22F 10/64; B22F 12/20; B33Y 10/00; B33Y 40/20

(52) U.S. Cl. CPC B22F 12/41; B22F 10/50; B22F 10/64; B22F 12/20; B33Y 10/00; B33Y 40/20

(57) ABSTRACT

The disclosure provides a method for additive manufacturing, including: a solidified layer forming process, in which a solidified layer is laminated by repeating a process of forming a material layer by supplying a material powder containing a metal material that expands with a tempering treatment, and a process of forming a solidified layer by irradiating the material layer with a laser beam or an electron beam, on a build table adjusted to a manufacturing temperature; and a thermal expansion treatment process, in which each time a predetermined number or a predetermined thickness of the solidified layer is newly formed, the temperature of the solidified layer is raised from the manufacturing temperature to a heating temperature, held for a predetermined time, and then lowered to the manufacturing temperature.

### CROSS-REFERENCE TO RELATED APPLICATIONS

This application claims the priority benefit of Japanese patent application serial No. 2023-096768, filed on Jun. 13, 2023. The entirety of the above-mentioned patent application is here by incorporated by reference herein and made a part of this specification.

### BACKGROUND

### Technical Field

The disclosure relates to a method for additive manufacturing.

### Description of Related Art

Various methods are known for additive manufacturing of three-dimensional objects. For example, in the powder bed fusion method, a material layer made of a material powder in a build region is formed on a build table, and a solidified layer is formed through sintering or melting of the material layer by scanning a laser beam or an electron beam and irradiating a predetermined position in the material layer. Further, a desired three-dimensional object is produced by repeating formation of the material layers and the solidified layers and laminating the solidified layers.

Patent Document 1 (U.S. Pat. No. 11,014,164B2) discloses a method for additive manufacturing that may suppress deformation and cracking of the manufactured object by intentionally progressing martensitic transformation each time one or more solidified layers are formed and controlling the residual stress of the manufactured object by reducing the tensile stress caused by contraction of the metal through the compressive stress caused by expansion accompanying martensitic transformation. Specifically, the solidified layer is cooled from the first temperature to the second temperature to advance martensitic transformation under temperature conditions that satisfy Mf≤T1, T2<T1, and T2≤Ms, where the first temperature is T1, the second temperature is T2, the martensitic transformation starting temperature of the solidified layer is Ms, and the martensitic transformation ending temperature of the solidified layer is Mf. The amount of martensitic transformation (amount of expansion) may be controlled by appropriately setting the first temperature and the second temperature under the above-mentioned temperature conditions. Further, the temperature of the solidified layer may be adjusted by, for example, providing a temperature adjusting device on the build table consisting of a heater and a cooler, and adjusting the build table to a set temperature corresponding to the first temperature or the second temperature using the temperature adjustment device.

In an additive manufacturing device of general specifications, the upper limit of the set temperature of the build table is about 200 to 350° C. Thus, when applying the method of Patent Document 1 to additive manufacturing using a metal material whose martensitic transformation starting temperature is relatively high at 200° C. or higher, the settable range of the first temperature that satisfies the above-mentioned temperature conditions is limited, and it is difficult to sufficiently suppress deformation and cracking of the manufactured object. One option would be to introduce a special build table with a higher upper limit for the set temperature, but there are concerns that heating the build table to an extremely high temperature could cause thermal displacement of surrounding components.

The disclosure has been made in view of these circumstances and provides a method for additive manufacturing that is capable of manufacturing a high-quality object and that is effective for metal materials whose martensitic transformation starting temperature is 200° C. or higher. Additional objects and advantages of the invention will be set forth in the description that follows.

### SUMMARY

The disclosure provides a manufacturing method, which is a method for additive manufacturing, including: a solidified layer forming process, in which a solidified layer is laminated by repeating a material layer forming process, in which a material layer is formed by supplying a material powder containing a metal material that expands with a tempering treatment, and a solidifying process, in which a solidified layer is formed by irradiating a predetermined region of the material layer with a laser beam or an electron beam, on a build table adjusted to a manufacturing temperature; and a thermal expansion treatment process, in which each time a predetermined number or a predetermined thickness of the solidified layer is newly formed, a temperature of the solidified layer is raised from the manufacturing temperature to a heating temperature, held at the heating temperature for a predetermined time, and then lowered to the manufacturing temperature, where a martensitic transformation starting temperature of the metal material is 200° C. or higher, and relationships of the following formulas (1) and (2) are satisfied: T1<T2≤350° C. (1) 50° C.≤T2−T1≤200° C. (2), where the manufacturing temperature is T1, and the heating temperature is T2.

### BRIEF DESCRIPTION OF THE DRAWINGS

FIG. 1 is a schematic diagram of the additive manufacturing device 100 according to the embodiment of the disclosure.

FIG. 2 is a perspective view of the material layer forming device 3.

FIG. 3 is a perspective view of the recoater head 32 of the material layer forming device 3 viewed from above.

FIG. 4 is a perspective view of the recoater head 32 of the material layer forming device 3 view from below.

FIG. 5 is an exploded perspective view of the build table 4 provided with the temperature adjusting device 42.

FIG. 6 is a diagram showing the method for additive manufacturing using the additive manufacturing device 100.

FIG. 7 is a diagram showing the method for additive manufacturing using the additive manufacturing device 100.

FIG. 8 is a graph showing the change in the set temperature of the build table 4 in the method for additive manufacturing using the additive manufacturing device 100.

FIG. 9 is a graph showing the temperature change of the top surface layer in the solidified layer forming process and the thermal expansion treatment process for the manufactured object on the build table 4.

FIG. 10 is a graph showing the temperature change of the top surface layer in the post-manufacturing heating process and the slow-cooling process for the manufactured object on the build table 4.

### DESCRIPTION OF THE EMBODIMENTS

The embodiment of the disclosure will be described below with reference to the drawings. The features shown in the following embodiments may be combined with each other. Further, each characteristic feature constitutes an invention independently.

### 1. Additive Manufacturing Device 100

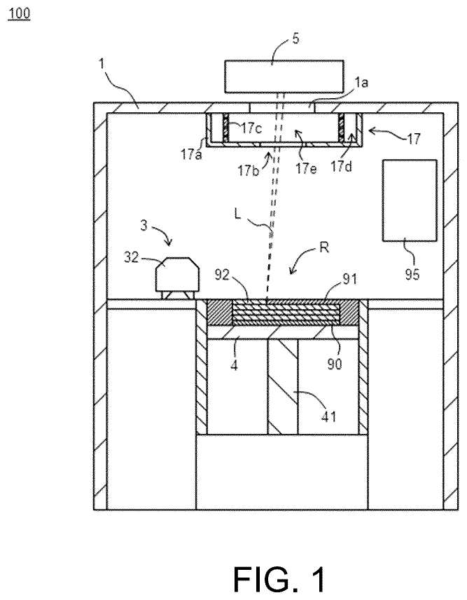

FIG. 1 shows an example of an additive manufacturing device 100 used in the additive manufacturing method of the present embodiment. The additive manufacturing device 100 includes a chamber 1, a material layer forming device 3, and an irradiation device 5. In a build region R provided on a build table 4 provided in the chamber 1, a desired object is additive manufactured by repeatedly forming a material layer 91 and a solidified layer 92. The application of the additive manufactured object manufactured by the additive manufacturing device 100 is not particularly limited, but the disclosure is particularly suitable for use in manufacturing an object used as a mold or die. The disclosure may be particularly suitably used in the manufacture of objects used as a mold that require higher strength and higher rigidity, such as a die for press working (hereinafter referred to as a press die).

### 1.1. Chamber 1

The chamber 1 covers the build region R, which is the region in which the desired object is formed. The chamber 1 is connected to an inert gas supply/exhaust device (not shown). The inert gas supply/exhaust device supplies a predetermined concentration of inert gas to the chamber 1, so that the chamber 1 is filled with inert gas. Further, the inert gas containing fumes generated with the formation of the solidified layer 92 is exhausted from the chamber 1, and after undergoing fume removal treatment in the inert gas supply/exhaust device, is supplied to the chamber 1 for reuse. It is noted that in this specification, the inert gas is a gas that does not substantially react with the material layer 91 or the solidified layer 92, and is appropriately selected from nitrogen gas, argon gas, helium gas, etc. in accordance with the type of the material for manufacturing.

For example, as shown in FIG. 1, a window 1a that serves as a transmission window for a laser beam L output from an irradiation device 5 is provided on the top surface of chamber 1. The window 1a is formed of a material that may transmit the laser beam L, and according to the type of the laser beam L, the material is selected from quartz glass, borosilicate glass, or crystals of germanium, silicon, zinc selenide, or potassium bromide. For example, when the laser beam L is a fiber laser or a YAG laser, the window 1a may be made of quartz glass.

Further, as shown in FIG. 1, a contamination prevention device 17 is provided on the top surface of the chamber 1 so as to cover the window 1a. The contamination prevention device 17 includes a cylindrical casing 17a and a cylindrical diffusion member 17c provided within the casing 17a. An inert gas supply space 17d is provided between the casing 17a and the diffusion member 17c. An opening 17b is provided on the bottom surface of the casing 17a inside the diffusion member 17c. The diffusion member 17c has a large number of fine holes, and clean inert gas supplied from the inert gas supply/exhaust device to the inert gas supply space 17d passes through the fine holes to fill a clean room 17e, and is ejected from the opening 17b toward the bottom of the contamination prevention device 17. With this configuration, the fumes are prevented from adhering to the window 1a and the fumes are removed from the irradiation path of the laser beam L.

### 1.2. Material Layer Forming Device 3

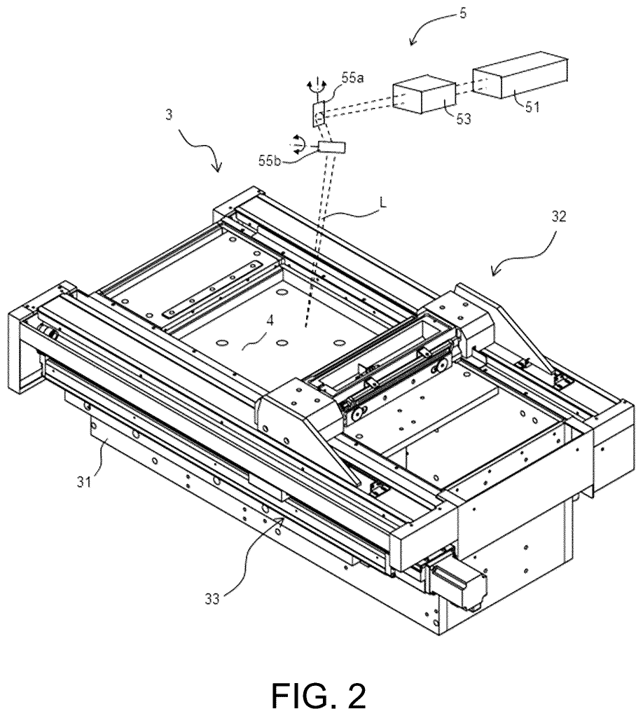

The material layer forming device 3 is provided inside the chamber 1. As shown in FIG. 2, the material layer forming device 3 includes a base 31 and a recoater head 32 provided on the base 31. The recoater head 32 is configured so as to be capable of reciprocating in one horizontal (axial) direction by a recoater head driving device 33 incorporating a driving mechanism such as a motor.

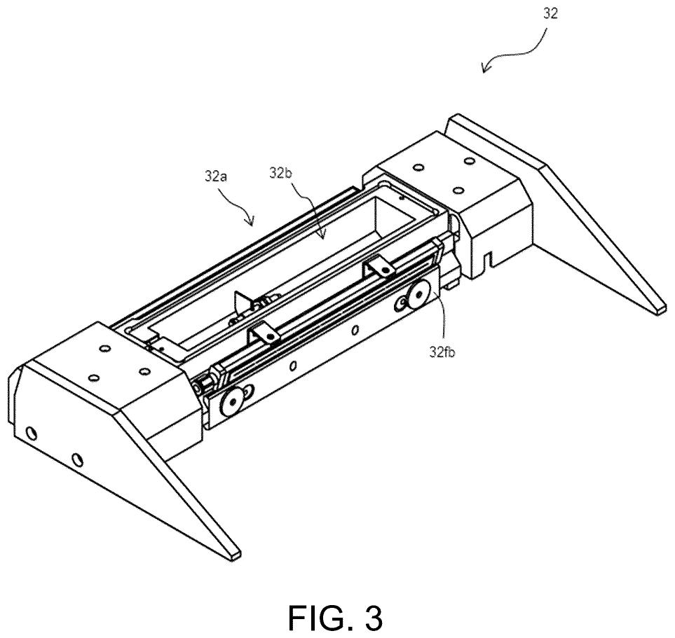

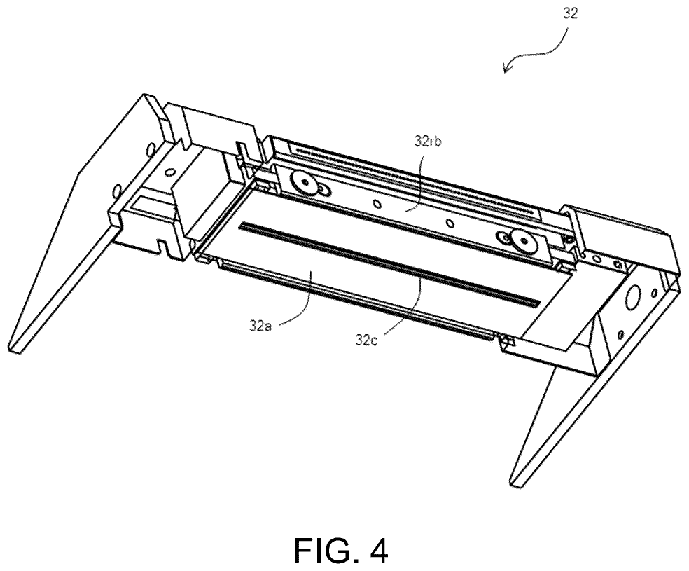

As shown in FIG. 3 and FIG. 4, the recoater head 32 includes a material container 32a, a material supply port 32b, and a material discharge port 32c. The material supply port 32b is provided on the top surface of the material container 32a and serves as a receiving port for the material powder supplied to the material container 32a from a material supply unit (not shown). The material discharge port 32c is provided on the bottom surface of the material container 32a and discharges the material powder inside the material container 32a. The material discharge port 32c has a slit shape extending in the longitudinal direction of the material container 32a. On two sides of the recoater head 32, flat-plate shaped blades 32fb and 32rb are provided. The blades 32fb and 32rb flatten the material powder discharged from the material discharge port 32c to form a material layer 91.

### 1.3. Irradiation Device 5

The irradiation device 5 irradiates the material layer 91 with a laser beam L or an electron beam to form a solidified layer 92. For example, as shown in FIG. 1, the irradiation device 5 of this embodiment is provided above the chamber 1, the irradiation region of the material layer 91 formed in the build region R is irradiated with the laser beam L to melt or sinter and then solidify the material powder, thereby forming the solidified layer 92. As shown in FIG. 2, the irradiation device 5 of this embodiment includes a laser light source 51, a focus control unit 53, an X-axis galvanometer mirror 55a, a Y-axis galvanometer mirror 55b, and an actuator (not shown) for rotating each of the X-axis galvanometer mirror 55a and the Y-axis galvanometer mirror 55b.

The laser light source 51 generates the laser beam L. The laser beam L may be any type capable of sintering or melting the material powder, and may be, for example, a fiber laser, a CO₂ laser, a YAG laser, or the like. The focus control unit 53 has focus control lenses therein and may focus the laser beam L and adjust the spot diameter.

The laser beam L that has passed through the focus control unit 53 is scanned two-dimensionally in an X-axis direction, which is one horizontal axial direction, and a Y-axis direction, which is another horizontal axial direction and is perpendicular to the X-axis direction. Specifically, the laser beam L is reflected by the X-axis galvanometer mirror 55a and scanned in the X-axis direction of the build region R, and is reflected by the Y-axis galvanometer mirror 55b and scanned in the Y-axis direction of the build region R. The laser beam L reflected by the X-axis galvanometer mirror 55a and the Y-axis galvanometer mirror 55b passes through the window 1a and is irradiated onto the material layer 91 in the build region R, whereby the solidified layer 92 is formed.

It is noted that the configuration of the irradiation device 5 is not limited thereto. For example, instead of the focus control unit 53, an fθ lens may be provided. Further, the irradiation device 5 may also be configured to irradiate the material layer 91 with an electron beam instead of the laser beam L to solidify the material layer 91 to form the solidified layer 92. Specifically, the irradiation device 5 may be configured to include a cathode electrode (not shown) that emits electrons; an anode electrode (not shown) that focuses and accelerates electrons; a solenoid (not shown) that forms a magnetic field to focus the electron beam in one direction; and a collector electrode (not shown) that is electrically connected to the material layer 91 that is the object to be irradiated and applies a voltage between the cathode electrode. At this time, the cathode electrode and the anode electrode function as an output source that outputs an electron beam, and the solenoid functions as a scanning means that scans the electron beam. It is noted that the window 1a and the contamination prevention device 17 may be omitted, and the cathode electrode may be provided so as to protrude into the chamber 1. Further, when an irradiation device that irradiates an electron beam is used, the atmosphere inside the chamber 1 may be a noble gas atmosphere close to a vacuum. The noble gases are sometimes called rare gases.

### 1.4. Build Table 4

As shown in FIG. 1, a build table 4 is provided in the chamber 1, and an object is formed in the build region R on the build table 4. The build table 4 is driven by a build table driving device 41 and may move in a vertical direction. When manufacturing, a base plate 90 is provided in the build region R, and the material layer forming device 3 supplies a material powder to the top surface of the base plate 90 to form the material layer 91.

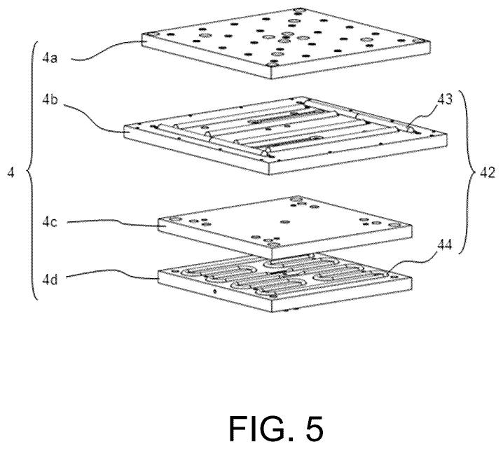

The additive manufacturing device 100 includes a temperature adjusting device 42 for adjusting the temperatures of the material layer 91 and the solidified layer 92. In this embodiment, the temperature adjusting device 42 is provided inside the build table 4, and the build table 4 is adjusted to a predetermined temperature by the temperature adjusting device 42, thereby adjusting the temperatures of the material layer 91 and the solidified layer 92 on the build table 4. As shown in FIG. 5, the temperature adjusting device 42 includes a heater 43 that heats the build table 4 and a cooler 44 that cools the build table 4.

Specifically, the build table 4 includes a top plate 4a and three support plates 4b, 4c, and 4d, the heater 43 capable of heating the top plate 4a is provided between the top plate 4a and the support plate 4b provided below it, and the cooler 44 capable of cooling the top plate 4a is provided between two support plates 4c and 4d below the support plate 4b.

The heater 43 is, for example, an electric heater having a heating element, or a tubular member configured so that a high-temperature heat medium may flow inside. The cooler 44 may be configured by, for example, providing, on the support plate 4d, a tubular member configured to allow the flow of a coolant supplied from a refrigerant circulation device (not shown), such as a chiller or a cooling tower. With this configuration, the top plate 4a at the top surface of the build table 4 may be heated or cooled to adjust the temperature to a predetermined level. The temperatures of the material layer 91 and the solidified layer 92 are adjusted by direct heat transfer between them and the top plate 4a, or by indirect heat transfer via the base plate 90 provided on the top plate 4a and a layer formed thereunder.

It is noted that the configuration of the temperature adjusting device 42 is not limited to the above-mentioned embodiment configuration. In this embodiment, the tubular member of the cooler 44 is sandwiched between the support plates 4c and 4d, for example, a pipe that circulates a coolant may be formed inside one or both of the support plates 4c and 4d, and the cooler 44 may be constituted by the pipe. Alternatively, the top plate 4a and the three support plates 4b, 4c, and 4d may be integrated into a structure body, and the heater 43 and the cooler 44 may be configured within the structure body. In order to prevent thermal displacement of the build table driving device 41, a constant temperature part held at a constant temperature may be provided between the temperature adjusting device 42 and the build table driving device 41.

### 2. Metal Material

The material layer 91 is formed using a material powder containing a metal material that expands with a tempering treatment and has a martensitic transformation starting temperature of 200° C. or higher. The tempering treatment refers to a treatment in which a metal material having an unstable structure after quenching treatment is reheated to a predetermined temperature, held at that temperature, and then cooled to promote transformation or precipitation of the structure, stabilize the structure, and improve toughness. By using a material powder containing a metal material with the above-mentioned properties, since the tensile stress caused by the contraction of the metal due to the temperature drop immediately after irradiation with the laser beam L is reduced by the compressive stress caused by the volume expansion with the heat treatment in the thermal expansion treatment process, the residual stress of the manufactured object may be controlled and the deformation and cracking of the manufactured object in the thermal expansion treatment process described below may be suppressed.

The metal material used as the material powder has a martensitic transformation starting temperature of 200° C. or higher, preferably 300° C. or higher, and more preferably 350° C. or higher. As mentioned above, in the case where the martensitic transformation starting temperature is relatively high, in the additive manufacturing device with general specifications in which the upper limit of the set temperature of the build table 4 is about 200 to 350° C., it was difficult to sufficiently suppress deformation and cracking of the object using the method disclosed in Patent Document 1, but by applying the disclosure, it is possible to achieve high-quality manufacturing.

An example of a metal material that expands with a tempering treatment and has a martensitic transformation starting temperature of 200° C. or higher is high speed steel as defined in JISG4403. Specific examples of high speed steel include molybdenum-based high speed steel (SKH50, SKH51, SKH52, SKH53, SKH54, SKH55, SKH56, SKH57, sKH58, SKH59, and SKH40) and tungsten-based high speed steels (SKH2, SKH3, SKH4, and SKH10). High speed steel is used, for example, as a material for molds and dies. High speed steel is used as a material for molds and dies, such as press dies, which require higher strength and higher rigidity.

High speed steel contains a relatively large amount of carbon, between 0.73 and 1.60% by mass Thus, during the process in which the solidified layer 92 is rapidly cooled from an extremely high temperature state after irradiation with the laser beam L or the electron beam to the normal temperature, cracks tend to develop starting from locations where carbides have precipitated, resulting in cracks. In order to avoid rapid cooling, although the build table 4 has been set to a relatively high temperature of about 300° C. and manufacturing has been performed while adjusting the temperature of the material layer 91 and the solidified layer 92, when the size of the manufactured object is large, temperature control is insufficient and it is extremely difficult to suppress cracks. In addition, since the martensitic transformation starting temperature of high speed steel is relatively high at 300 to 400° C., the technical significance of applying the disclosure is particularly remarkable, as described above.

The material powder preferably contains a metal material that expands with a tempering treatment and has a martensitic transformation starting temperature of 200° C. or higher in an amount of 50% by mass or more of the entire material powder, more preferably 80% by mass or more of the entire material powder, and even more preferably 95% by mass or more of the entire material powder. Further, the material powder may be composed only of a metal material that expands with a tempering treatment and has a martensitic transformation starting temperature of 200° C. or higher.

The base plate 90 may be made of a metal material similar to the material powder, or may be made of a metal material having a different composition, such as iron.

### 3. Method for Additive Manufacturing

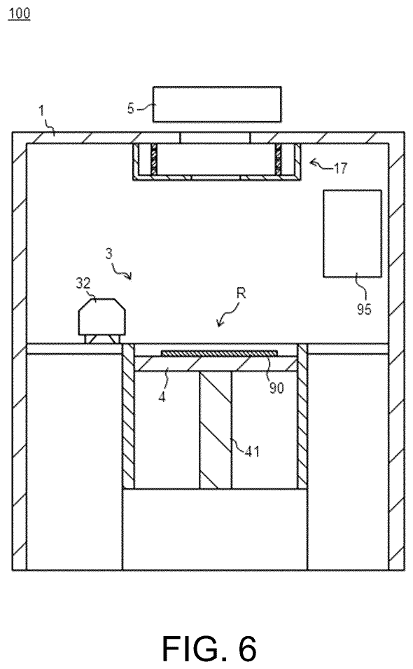

Next, a method for additive manufacturing using the additive manufacturing device 100 described above will be described with reference to FIG. 6 to FIG. 10. The manufacturing method in this embodiment includes a solidified layer forming process, in which a solidified layer 92 is laminated by repeating a material layer forming process, in which a material layer 91 is formed by supplying a material powder containing a metal material that expands with a tempering treatment, and a solidifying process, in which the solidified layer 92 is formed by irradiating a predetermined region of the material layer 91 with a laser beam L or an electron beam, on a build table 4 adjusted to a manufacturing temperature T1; and a thermal expansion treatment process, in which each time a predetermined number or a predetermined thickness of the solidified layer 92 is newly formed, a temperature of the solidified layer 92 is raised from the manufacturing temperature T1 to a heating temperature T2, held at the heating temperature T2 for a predetermined time, and then lowered to the manufacturing temperature T1. Further, the manufacturing method in this embodiment further includes a post-manufacturing heating process, in which the temperature of the solidified layer 92 is raised from the manufacturing temperature T1 to the heating temperature T2 and held at the heating temperature T2 for a predetermined time after completion of manufacturing the object; and a slow-cooling process, in which the solidified layer 92 is slowly cooled from the heating temperature T2 to normal temperature Tn after the post-manufacturing heating process.

### 3.1. Solidified Layer Forming Process

The solidified layer forming process includes a material layer forming process and a solidifying process. In the material layer forming process, the material layer 91 made of material powder is formed in the build region R. Further, in the solidifying process, the laser beam L is applied to the predetermined irradiation region of the material layer 91 to form the solidified layer 92. The material layer forming process and the solidifying process are performed repeatedly. It is noted that in the following description, the solidified layer 92 of a predetermined number or a predetermined thickness newly formed by the solidified layer forming process may be referred to as a top surface layer.

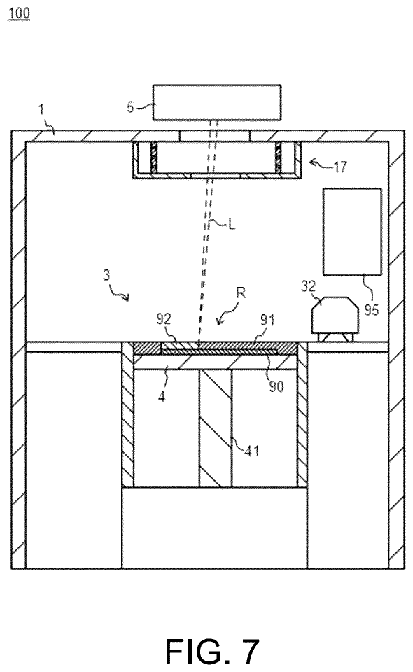

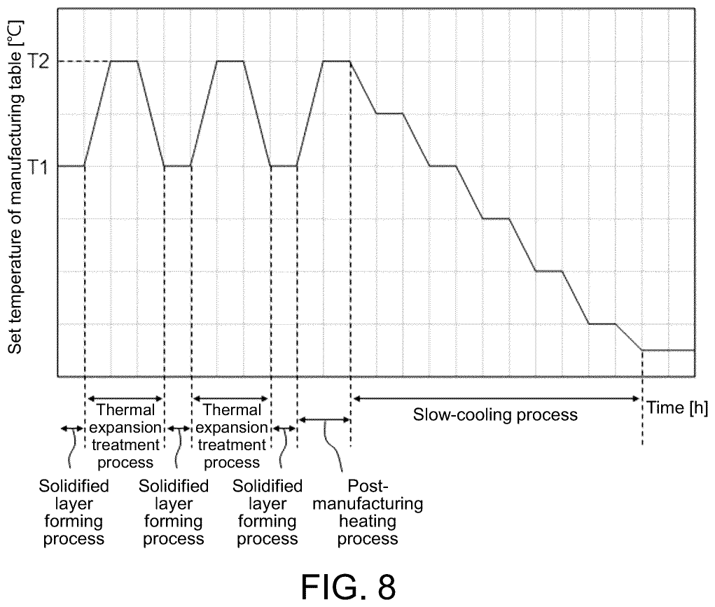

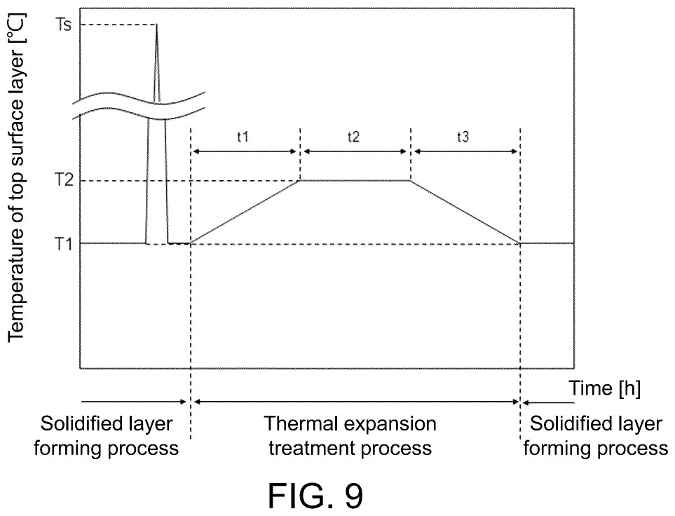

First, a first material layer forming process is performed. FIG. 8 is a graph showing the change in the temperature of the build table 4 in the manufacturing method of this embodiment. FIG. 9 is a graph showing the temperature change of the top surface layer in the solidified layer forming process and the thermal expansion treatment process. In the solidified layer forming process including the material layer forming process, the build table 4 is adjusted to the manufacturing temperature T1. In this embodiment, the top plate 4a is heated by the heater 43 of the temperature adjusting device 42, so that the build table 4 is adjusted to the manufacturing temperature T1. Then, with the base plate 90 placed on the build table 4 adjusted to the manufacturing temperature T1, the height of the build table 4 is adjusted to an appropriate position. In this state, the recoater head 32 is moved from the left side to the right side in FIG. 6, whereby a first material layer 91 is formed on the base plate 90 as shown in FIG. 7. The material layer 91 is preheated to the manufacturing temperature T1 by heat transfer from the top plate 4a through the base plate 90.

Next, a first solidifying process is performed. As shown in FIG. 7, the laser beam L is applied to a predetermined irradiation region of the first material layer 91 to solidify the first material layer 91, thereby obtaining a first solidified layer 92. Here, in the solidifying process, the build table 4 is held at the manufacturing temperature T1. As shown in FIG. 9, the newly formed solidified layer 92 is at a very high temperature (temperature Ts) of about 1400° C. to 1600° C. immediately after irradiation with the laser beam L, after the irradiation is completed, the temperature is lowered so as to reach thermal equilibrium with the build table 4, and after a predetermined time has elapsed, the temperature reaches the manufacturing temperature T1. Metals have a positive coefficient of thermal expansion, so their volume shrinks with such a decrease in temperature. However, since the amount of shrinkage is limited by the base plate 90 and by adhesion with adjacent layers, tensile stress remains in the manufactured object.

Then, a second material layer forming process is performed. After the first solidified layer 92 is formed, the height of the build table 4 is lowered by one material layer 91. In this state, the recoater head 32 is moved from the right side to the left side of the build region R in FIG. 7, whereby a second material layer 91 is formed so as to cover the first solidified layer 92. Then a second solidifying process is performed. In the same manner as described above, a laser beam L or an electron beam is applied to a predetermined irradiation region of the second material layer 91 to solidify the second material layer 91, thereby obtaining a second solidified layer 92.

The material layer forming process and the solidifying process are repeated to laminate a plurality of solidified layers 92 until the desired three-dimensional object is obtained. Adjacent solidified layers 92 are strongly adhered to one another.

### 3.2. Thermal Expansion Treatment Process

The thermal expansion treatment process is performed each time a predetermined number or a predetermined thickness of the solidified layer 92 is newly formed by the solidified layer forming process.

As shown in FIG. 9, in the thermal expansion treatment process, first, in the material layer forming process, the solidified layer 92, which is in thermal equilibrium with the build table 4 and has the temperature held at the manufacturing temperature T1, has the temperature raised from the manufacturing temperature T1 to the heating temperature T2 and held at the heating temperature T2 for a predetermined time. In this embodiment, the top plate 4a is heated by the heater 43 of the temperature adjusting device 42, so that the build table 4 is adjusted to the heating temperature T2, and the temperature of the solidified layer 92 is adjusted to and held at the heating temperature T2 by heat transfer from the top plate 4a through the base plate 90 and the layers formed thereunder.

Subsequently, the temperature of the solidified layer 92 is lowered to the manufacturing temperature T1. In this embodiment, the top plate 4a is cooled by the cooler 44 of the temperature adjusting device 42, so that the build table 4 is adjusted from the heating temperature T2 to the manufacturing temperature T1, and the temperature of the solidified layer 92 is adjusted to the manufacturing temperature T1 by heat transfer from the top plate 4a through the base plate 90 and the layers formed thereunder. It is noted that in the following description, in the thermal expansion treatment process, a series of treatment in which the temperature of the solidified layer 92 is raised from the manufacturing temperature T1 to the heating temperature T2, held at the heating temperature T2 for a predetermined time, and subsequently has the temperature lowered from the heating temperature T2 to the manufacturing temperature T1 are sometimes referred to as a thermal expansion treatment.

The manufacturing temperature T1 and the heating temperature T2 are set so as to satisfy the relationships of the following formulas (1) and (2).

$$T 1 < T 2 ≦ 350 ° C . \qquad ( 1 )$$

$$50 ° C . ≦ T 2 - T 1 ≦ 200 ° C . \qquad ( 2 ) ,$$

In this embodiment, as an example, the manufacturing temperature T1 is set to 200° C., and the heating temperature T2 is set to 300° C.

It is noted that the thermal expansion treatment needs to be performed at least on the top surface layer. In this embodiment, since the temperature adjusting device 42 is provided in the build table 4, thermal expansion treatment is performed on the entire solidified body obtained by laminating the solidified layers 92, that is, the top surface layer and the solidified layers 92 below the top surface layer.

The heating temperature T2 in the thermal expansion treatment is set to a temperature much lower than the heating temperature in a general tempering treatment (e.g., 500° C. or higher in the case of high speed steel). Thus, the above-mentioned thermal expansion treatment is a heat treatment different from the tempering treatment, and does not exhibit the effects of the tempering treatment, such as improving toughness. However, when using a material powder containing a metal material that expands with a tempering treatment and has a martensitic transformation starting temperature of 200° C. or higher, by performing thermal expansion treatment on the solidified layer 92 at the manufacturing temperature T1 and heating temperature T2 set so as to satisfy the above relationship, the same volumetric expansion as during the tempering treatment may be generated. As a result, since the tensile stress caused by the contraction of the metal is reduced by the compressive stress caused by the expansion with the thermal expansion treatment, the residual stress of the manufactured object may be controlled and the deformation and cracking of the manufactured object may be suppressed.

It is noted that the manufacturing temperature T1 and the heating temperature T2 satisfy the relationship T1<T2≤350° C., and preferably satisfy the relationship T1<T2≤300° C. In this case, thermal expansion treatment may be easily performed even on an additive manufacturing device of general specifications, and the thermal effects on peripheral members constituting the additive manufacturing device 100 may be suppressed.

The lower limit of the manufacturing temperature T1 is not particularly limited, but the manufacturing temperature T1 is, for example, 100° C. or higher, and preferably 150° C. or higher. The heating temperature T2 is preferably 200° C. or higher so as to more effectively control the residual stress of the manufactured object. In this case, the heating temperature T2 is 200° C. or higher and 350° C. or lower, and preferably 200° C. or higher and 300° C. or lower. It is noted that the difference (T2−T1) between the manufacturing temperature T1 and the heating temperature T2 satisfies the relationship 50° C. T2−T1≤200° C., and preferably satisfies the relationship 100° C. T2−T1≤200° C. The amount of volume expansion with the thermal expansion treatment depends on the difference (T2−T1) between the manufacturing temperature T1 and the heating temperature T2, and the greater the difference (T2−T1), the greater the amount of volume expansion.

As shown in FIG. 9, in the thermal expansion treatment process, for the solidified layer 92, the time required to raise the temperature from the manufacturing temperature T1 to the heating temperature T2 (temperature rising time) is referred to as t1, the time to hold the heating temperature T2 (temperature holding time) is referred to as t2, and the time required to lower the temperature from the heating temperature T2 to the manufacturing temperature T1 (cooling time) is referred to as t3. The temperature rising time t1 is preferably one hour or more, and is set to one hour in this embodiment. The temperature holding time t2 is preferably one hour or more, and is set to one hour in this embodiment. The cooling time t3 is preferably one hour or more, and is set to one hour in this embodiment.

It is noted that the thermal expansion treatment process may be performed during the manufacturing process, and may be performed each time one solidified layer 92 is formed, each time a plurality of solidified layers 92 are newly formed, or each time a new solidified layer 92 of a predetermined thickness (e.g., 1 to 10 mm) is formed. In addition, the execution cycle of the thermal expansion treatment process may be changed during the course of the manufacturing. In addition, in test manufacturing conducted as a preliminary investigation of additive manufacturing, manufacturing is performed without the thermal expansion treatment, the number of laminated layers or the laminated height at the time when cracks occur in the manufactured object due to the laminating of the solidified layer 92 is investigated, and the execution cycle of the thermal expansion treatment process may be set based on the number of laminated layers or the height of laminated layers. In this case, for example, the thermal expansion treatment process may be performed each time a new solidified layer 92 is formed, the number or thickness of which does not exceed the number of layers or the height of the layers.

### 3.3. Post-Manufacturing Heating Process and Slow-Cooling Process

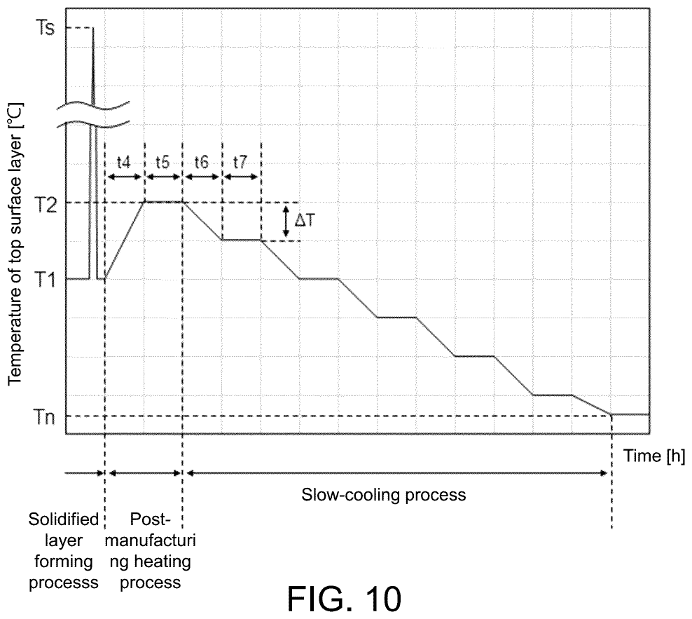

The post-manufacturing heating process is performed after the manufacturing is completed, that is, after all the solidified layers 92 have been formed. As shown in FIG. 10, in the post-manufacturing heating process, the temperature of the solidified layer 92 is raised from the manufacturing temperature T1 to the heating temperature T2, and is held at the heating temperature T2 for a predetermined time. In the slow-cooling process, which is a process performed after the post-manufacturing heating process, the solidified layer 92 is slowly cooled from the heating temperature T2 to a normal temperature Tn (5° C. to 35° C.). In this embodiment, as shown in FIG. 10, the solidified layer 92 is slowly cooled by lowering a temperature of the solidified layer 92 from the heating temperature T2 to the normal temperature Tn in a stepwise manner by repeatedly lowering the temperature by a predetermined temperature at predetermined time intervals and then holding the temperature. In this way, the residual stress of the manufactured object may be controlled by performing a heat treatment similar to the thermal expansion treatment on the top surface layer formed in the final stage of manufacturing. In addition, after completion of manufacturing, the solidified layer 92 is rapidly cooled to the normal temperature Tn, which may suppress the occurrence of cracks in the manufactured object.

The temperature of the solidified layer 92 in the post-manufacturing heating process and the slow-cooling process may be adjusted by adjusting the temperature of the build table 4 as shown in FIG. 8.

As shown in FIG. 10, in the post-manufacturing heating process, for the solidified layer 92, the time required to raise the temperature from the manufacturing temperature T1 to the heating temperature T2 (temperature rising time) is referred to as t4, and the time to hold the heating temperature T2 (temperature holding time) is referred to as t5. The temperature rising time t4 is preferably one hour or more, and is set to one hour in this embodiment. The temperature holding time t5 is preferably one hour or more, and is set to one hour in this embodiment.

Further, in the slow-cooling process, a cooling time t6, which is the time required for one temperature drop when the temperature of the solidified layer 92 is lowered stepwise, is preferably one hour or more, and is set to one hour in this embodiment. Further, a temperature holding time t7 after the temperature drop is preferably one hour or more, and is set to one hour in this embodiment. Further, the temperature drop width ΔT, which is the temperature width in one temperature drop, is, for example, 30° C. or higher and 70° C. or lower, and is set to 50° C. in this embodiment.

The slow-cooling process is not limited to the configuration in which the temperature of the solidified layer 92 is lowered stepwise as in the present embodiment. For example, the slow-cooling process may be performed by continuously lowering the temperature of the solidified layer 92 over a relatively long period of time. Further, the manufacturing may be completed without performing the post-manufacturing heating process and the slow-cooling process.

During or after the manufacturing is completed, a machining device 95 provided in the chamber 1 may be used to perform machining such as cutting and polishing on the surface of the solidified body obtained by laminating the solidified layers 92 and on unnecessary parts. After the above processes are completed, the unsolidified material powder and cutting chips are discharged to obtain a manufactured object.

### 4. Other Embodiments

The disclosure may also be performed in the following manner.

In the above-mentioned embodiment, the temperature adjusting device 42 is provided inside the build table 4, and the material layer 91 and the solidified layer 92 are heated or cooled from below through the base plate 90 and the lower layer to adjust the temperature. The configuration of the temperature adjusting device 42 is not limited to this example, and for example, the temperature adjusting device 42 may be configured to heat or cool the material layer 91 and the solidified layer 92 from above. In this case, for example, a halogen lamp or the like may be used as the heater 43. Moreover, the cooler 44 may be configured such that a cooling plate cooled by a blower that blows cooling gas of the same type as the inert gas filled in the chamber 1 onto the material layer 91 and the solidified layer 92 from above, or a Peltier element or the like is brought into contact with the material layer 91 and the solidified layer 92 from above. According to such a temperature adjusting device 42, the temperatures of the material layer 91 and the part of the solidified layer 92 constituting the top surface layer may be adjusted directly to the manufacturing temperature T1 and the heating temperature T2 without going through the base plate 90 and the lower layer, and even after the plurality of solidified layers 92 are formed, the temperature may be adjusted quickly.

Hereinafter, detailed contents will be described using the embodiment, but the disclosure is not limited to the following embodiment.

In Example 1, Example 2, and Comparative example 1, a manufactured object was formed by additive manufacturing on the top surface of the base plate 90 provided on the build table 4 including the temperature adjusting device 42, and the presence or absence of cracks was confirmed.

### Example 1

In Example 1, an object was manufactured on the top surface of the base plate 90 (material: S50C, rectangular parallelepiped shape with dimensions of length 125×width 125×thickness 15 mm) using a material powder (manufactured by Hoganas, high speed steel powder M2) corresponding to SKH51, which is a high-speed steel, using the additive manufacturing device 100 (manufactured by Sodick Co., Ltd., OPM250L, upper limit of set temperature of build table 4: 300° C.). In the solidified layer forming process, the manufacturing temperature T1 was set to 200° C. When manufacturing, a thermal expansion treatment process was performed each time a 1 mm solidified layer 92 was newly formed. In the thermal expansion treatment process, the heating temperature T2 was set to 300° C., the temperature rising time t1 was set to 1 hour, the temperature holding time t2 was set to 1 hour, and the cooling time t3 was set to 1 hour. After completion of manufacturing, a post-manufacturing heating process and a slow-cooling process were performed. In the post-manufacturing heating process, the temperature rising time t4 was set to 1 hour, and the temperature holding time t5 was set to 1 hour. In the slow-cooling process, the cooling time t6 was set to 1 hour, the temperature holding time t7 was set to 1 hour, and the temperature drop width ΔT was set to 50° C., and the solidified layer 92 was slowly cooled by lowering a temperature of the solidified layer 92 in a stepwise manner.

### Example 2

In Example 2, the manufactured object was formed under the same conditions as Example 1, except that the manufactured object was a rectangular parallelepiped shape with dimensions of length 80 mm×width 80 mm×thickness 10 mm.

### Comparative Example 1

In Comparative Example 1, the manufactured object had a substantially cylindrical shape with a base radius of 10 mm and a height of 45 mm. In the solidified layer forming process, the manufacturing temperature T1 was set to 300° C. The thermal expansion treatment process, the post-manufacturing heating process, and the slow-cooling process were not performed. Otherwise, the manufacturing was performed under the same conditions as for Example 1.

### <Results>

The manufactured objects of Example 1 and Example 2 did not crack during manufacturing, after completion of manufacturing, or one week after the slow-cooling process was performed. During manufacturing, the manufactured object of Comparative Example 1 was cracked at a time point at which the manufactured object was manufactured to a height of 35 mm.

Generally, the larger the size of the manufactured object in the horizontal direction, the more likely it is that cracks occur due to tensile stress caused by contraction of the metal due to temperature drop immediately after irradiation with the laser beam L. In Comparative Example 1, cracks occurred in the manufactured object, whereas in Example 2 where the size of the manufactured object is larger, no cracks occurred, indicating that the implementation of the thermal expansion treatment process is effective in suppressing cracks in the manufactured object.

In the method for additive manufacturing according to the disclosure, a material powder containing a metal material that expands with a tempering treatment is used. Further, in the thermal expansion treatment process, each time a predetermined number or a predetermined thickness of the solidified layer is newly formed, the temperature of the solidified layer is raised from the manufacturing temperature to a heating temperature, held for a predetermined time, and then lowered to the manufacturing temperature. As a result, since the tensile stress caused by the contraction of the metal is reduced by the compressive stress caused by the expansion with heat treatment in the thermal expansion treatment process, the residual stress of the manufactured object may be controlled and the deformation and cracking of the manufactured object may be suppressed. The manufacturing method of the disclosure is effective for metal materials that expand with a tempering treatment and whose martensitic transformation starting temperature is 200° C. or higher. In addition, since the manufacturing temperature and the heating temperature are set so as to satisfy the relationship between the above-mentioned formulas (1) and (2), the process may be performed using an additive manufacturing device of general specifications in which the upper limit of the set temperature of the build table is about 200 to 350° C.

Although various embodiments of the disclosure have been described, these embodiments are mere examples and are not intended to limit the scope of the invention. Novel embodiments may be implemented in various other forms, and various omissions, replacements, and changes may be made without departing from the gist of the invention. These embodiments and their modifications are included within the scope and gist of the invention, as well as within the scope of the invention described in the claims and its equivalents.

What is claimed is:

1. A method for additive manufacturing, comprising:
a solidified layer forming process, in which a solidified layer is laminated by repeating a material layer forming process, in which a material layer is formed by supplying a material powder containing a metal material that expands with a tempering treatment, and a solidifying process, in which a solidified layer is formed by irradiating a predetermined region of the material layer with a laser beam or an electron beam, on a build table adjusted to a manufacturing temperature; and
a thermal expansion treatment process, in which each time a predetermined number or a predetermined thickness of the solidified layer is newly formed, a temperature of the solidified layer is raised from the manufacturing temperature to a heating temperature, held at the heating temperature for a predetermined time, and then lowered to the manufacturing temperature,
wherein a martensitic transformation starting temperature of the metal material is 200° C. or higher, and
relationships of the following formulas (1) and (2) are satisfied:
$$T 1 < T 2 ≦ 350 ° C . \qquad ( 1 )$$
$$50 ° C . ≦ T 2 - T 1 ≦ 200 ° C . \qquad ( 2 ) ,$$
where the manufacturing temperature is T1, and the heating temperature is T2.

2. The method for additive manufacturing according to claim 1, wherein
the manufacturing temperature is 100° C. or higher.

3. The method for additive manufacturing according to claim 1, wherein
the heating temperature is 200° C. or higher and 350° C. or lower.

4. The method for additive manufacturing according to claim 3, wherein
the manufacturing temperature is 150° C. or higher.

5. The method for additive manufacturing according to claim 1, wherein
the predetermined time for holding the heating temperature is one hour or more.

6. The method for additive manufacturing according to claim 5, wherein
a time required to raise temperature from the manufacturing temperature to the heating temperature is 1 hour or more.

7. The method for additive manufacturing according to claim 5, wherein
a time required to lower temperature from the heating temperature to the manufacturing temperature is 1 hour or more.

8. The method for additive manufacturing according to claim 1, wherein
the metal material is high speed steel.

9. The method for additive manufacturing according to claim 1, further comprising:
a post-manufacturing heating process, in which a temperature of the solidified layer is raised from the manufacturing temperature to the heating temperature and held at the heating temperature for a predetermined time after completion of manufacturing an object; and
a slow-cooling process, in which the solidified layer is slowly cooled from the heating temperature to a normal temperature after the post-manufacturing heating process.

10. The method for additive manufacturing according to claim 9, wherein
in the slow-cooling process, the solidified layer is slowly cooled by lowering a temperature of the solidified layer from the heating temperature to the normal temperature in a stepwise manner by repeatedly lowering the temperature by a predetermined temperature at predetermined time intervals and then holding the temperature.
